(19) United States
(12) Patent Application Publication
(10) Pub. No.: US 2021/0302659 A1
(43) Pub. Date: Sep. 30, 2021

(54) TUNABLE OPTICAL FILTER WITH BANDWIDTH TUNING CAPABILITY

(71) Applicant: DICON FIBEROPTICS, INC., Richmond, CA (US)

(72) Inventors: Ho-Shang Lee, El Sobrante, CA (US); Jeffrey Lee, El Sobrante, CA (US)

(73) Assignee: DICON FIBEROPTICS, INC., Richmond, CA (US)

(21) Appl. No.: 17/003,067

(22) Filed: Aug. 26, 2020

Related U.S. Application Data
(60) Provisional application No. 63/002,884, filed on Mar. 31, 2020.

(51) Int. Cl. G02B 6/293

(52) U.S. Cl. CPC G02B 6/29313; G02B 6/29395

(57) ABSTRACT

Wavelength-tuning optical filters are presented that also allows for the tuning or real-time adjustment of its bandwidth, or passband width. The bandwidth-adjustable tunable optical filters use one or more diffraction gratings that are fixed in place to provide angular dispersion of different wavelengths. A first rotatable or tilting mirror is used to adjust the angle of incidence of an input optical beam to the diffraction grating or diffraction grating system, while a second rotatable or tilting mirror is used to aim the diffracted optical beam back through the diffraction grating or diffraction grating system, so that a subset of the incoming wavelengths are optically aligned to the end face of an output fiber. The first rotatable or tilting mirror provides tuning or adjustment of the bandwidth or passband width of the tunable optical filter, while the second rotatable or tilting mirror tunes or adjusts the center wavelength of the passband.

### PRIORITY CLAIM

This application claims the benefit of U.S. provisional patent application No. 63/002,884, filed Mar. 31, 2020, which is hereby incorporated in its entirety by this reference.

### BACKGROUND

This disclosure relates to tunable optical filters.

Tunable optical filters are a basic building block of modern, reconfigurable optical networks that make use of Wavelength Division Multiplexing (WDM). Tunable optical filters allow rapid reconfiguration of the specific wavelength bands or channels that are being added to, or dropped from, a multi-wavelength optical signal. Tunable optical filters are also used to reduce or eliminate noise, in particular Amplified Spontaneous Emission (ASE) noise, in an optical signal that is sourced from a transmitter or transceiver that incorporates a tunable laser.

Prior art tunable optical filters typically provide a fixed bandwidth, or passband width, while allowing tuning of the center wavelength of the passband. This was perfectly acceptable in optical networks that utilized fixed-bandwidth channels, such as Dense Wavelength Division Multiplexing (DWDM) networks comprising 40 channels with a 100 GHz channel spacing (channel width of approximately 0.8 nm) or 80 channels with a 50 GHz channel spacing (channel width of approximately 0.4 nm). However, with the advent of coherent optics, and advanced photonic modulation schemes, the amount of bandwidth or channel width required for a given channel has become variable, dependent on baud rate, modulation scheme or format, and other variables. In a typical optical networking wavelength band, for example the C band or L band, the channel spacing among wavelength channels in a modern WDM system is not necessarily fixed and different channels may have different bandwidth requirements.

### SUMMARY

In one set of embodiments, a tunable optical filter device includes an optical input port, an optical output port, and a diffraction element in an optical path between the input port and the output port, the diffraction element configured to differentially diffract light incident thereupon as based upon wavelength of the incident light. A first rotatable reflector in the optical path is configured to direct at least a portion of light having a wavelength spectrum incident thereupon from the input port to be incident upon the diffraction element, where the angle of incidence upon the diffraction element is dependent on the angle of the first rotatable reflector. A second rotatable reflector in the optical path is configured to direct at least a portion of light incident thereupon from the diffraction element to be incident upon an output port. One or more control circuits are connected to, and configured to independently rotate, the first reflector and the second reflector. The one or more control circuits are further configured to rotate the first reflector to provide the light incident upon the output port to have a selected bandwidth of wavelengths and to rotate the second reflector to align light incident upon the output port to have a selected wavelength center.

In another set of embodiments, a method includes receiving a beam of light at an optical input port; directing, by a first rotatable reflector, at least a portion of the beam of light to be incident on a diffraction element, the diffraction element configured to differentially diffract light incident thereupon as based upon wavelength of the incident light; and directing, by a second rotatable reflector, light diffracted by the diffraction element to be incident on an optical output port. The method also includes rotating, in response to a first user input, the first reflector to provide the light incident upon the output port to have a selected bandwidth of wavelengths; and rotating, in response to a second user input, the second reflector to align light incident upon the output port to have a selected wavelength center.

Various aspects, advantages, features, and embodiments are included in the following description of examples thereof, which description should be taken in conjunction with the accompanying drawings. All patents, patent applications, articles, other publications, documents, and things referenced herein are hereby incorporated herein by this reference in their entirety for all purposes. To the extent of any inconsistency or conflict in the definition or use of terms between any of the incorporated publications, documents or things and the present application, those of the present application shall prevail.

### BRIEF DESCRIPTION OF THE DRAWINGS

FIG. 1 shows an optical filter that provides wavelength tuning and a form of adjustable bandwidth or passband width using two diffraction gratings.

FIGS. 2A and 2B illustrate the effects of a diffraction grating on an incident light beam.

FIG. 3 shows one embodiment comprising a tunable optical filter with both wavelength tuning and tuning or adjustment of the passband width, and using a single diffraction grating and two rotatable or tilting mirrors.

FIG. 4 illustrates with greater detail a portion of the optical path through the embodiment shown in FIG. 3.

FIG. 5 shows an alternate embodiment using two diffraction gratings for greater angular dispersion of different wavelengths.

FIG. 6 is a flowchart for an embodiment of a method for operating a tunable optical filter device, such as presented above, to provide an output having a selected bandwidth of wavelengths about a selected wavelength center.

### DETAILED DESCRIPTION

With the advent of coherent optics, and advanced photonic modulation schemes, the amount of bandwidth or channel width required for a given channel has become variable, dependent on baud rate, modulation scheme or format, and other variables. In a typical optical networking wavelength band, for example the C band or L band, the channel spacing among wavelength channels in a modern WDM system is not necessarily fixed and different channels may have different bandwidth requirements. As a result, there is a need for a wavelength-tuning filter that also has the capability of simultaneously and independently adjusting its bandwidth, or passband width. Higher speed optical signals using advanced modulation schemes require more bandwidth, and therefore a wider passband, compared to lower speed optical signals with narrower spectral content. As both types of optical signals may co-exist on a modern WDM network, reconfiguring of the network requires wavelength tuning, as well as tuning or adjusting of the passband width. Similarly, noise filters downstream of a tunable optical transmitter or transceiver may also benefit from tunable or adjustable passband width, if the transmitter or transceiver is capable of supporting a variety of optical signal formats, with different bandwidth requirements. To address this, the following presents embodiments of a wavelength-tuning optical filter that also allows for the tuning or real-time adjustment of its bandwidth, or passband width. The tuning or adjustment of passband width is independent of the tuning of the center wavelength of the passband.

More specifically, the following presents wavelength-tuning optical filters that also allow for the tuning or real-time adjustment of the filters' bandwidth, or passband width. The bandwidth-adjustable tunable optical filters use one or more diffraction gratings that are fixed in place to provide angular dispersion of different wavelengths. A first rotatable or tilting mirror is used to adjust the angle of incidence of an input optical beam to the diffraction grating or diffraction grating system, while a second rotatable or tilting mirror is used to aim the diffracted optical beam back through the diffraction grating or diffraction grating system, so that a subset of the incoming wavelengths are optically aligned to the end face of an output fiber. Alternatively, the second rotatable or tilting mirror may be used to aim the diffracted optical beam at the end face of an output fiber, without first passing back thorough the diffraction grating or diffraction grating system. Thus, the first rotatable or tilting mirror provides tuning or adjustment of the bandwidth or passband width of the tunable optical filter, while the second rotatable or tilting mirror tunes or adjusts the center wavelength of the passband.

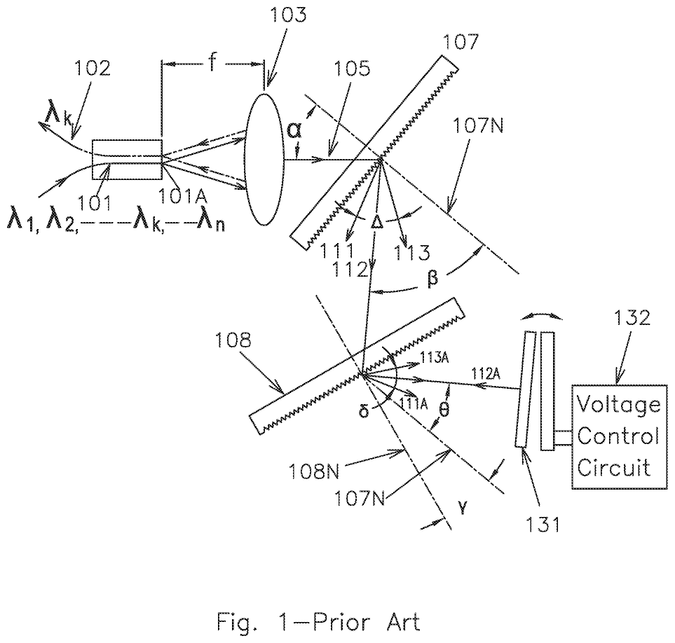

FIG. 1 shows an example of an optical filter, as described in detail in U.S. Pat. No. 9,720,250. This tunable optical filter uses two diffraction gratings (107 and 108) that are positioned such that there is an included angle between them. Tuning of the center wavelength of this prior art embodiment is accomplished by changing the angle of a tilting or rotating mirror (131). However, if the two diffraction gratings are fixed in place, the width of the passband is fixed, and is dependent on the overall dispersion coefficient of the two diffraction gratings, the dimensions of the core of the output fiber 102, and the length of the optical path between the input fiber (101) and the output fiber (102). The overall dispersion coefficient of the two diffraction gratings is dependent on the included angle.

As is further described in U.S. Pat. No. 9,720,250, if one or both of the diffraction gratings could be made electrically rotatable in order to adjust the dispersion coefficient of the grating system, this would allow adjustment or tuning of the bandwidth or passband width of the tunable optical filter in real-time. However, in practice the diffraction gratings may be too large and heavy to be moved by a typical Micro-ElectroMechanical System (MEMS) mechanism. Mechanical or piezo-electric driven mechanisms are also too bulky for most applications of a tunable optical filter component. Thus, there is a need for a tunable optical filter with real-time adjustment or tuning of bandwidth, that does not require movement of the large and heavy diffraction gratings.

A diffraction grating is an optical component that can split or disperse a beam having multiple wavelengths, into individual wavelength components at different angles. The angular dispersion of the different wavelengths is typically achieved using a periodic structure, such as an array of grooves on the surface of an optical substrate.

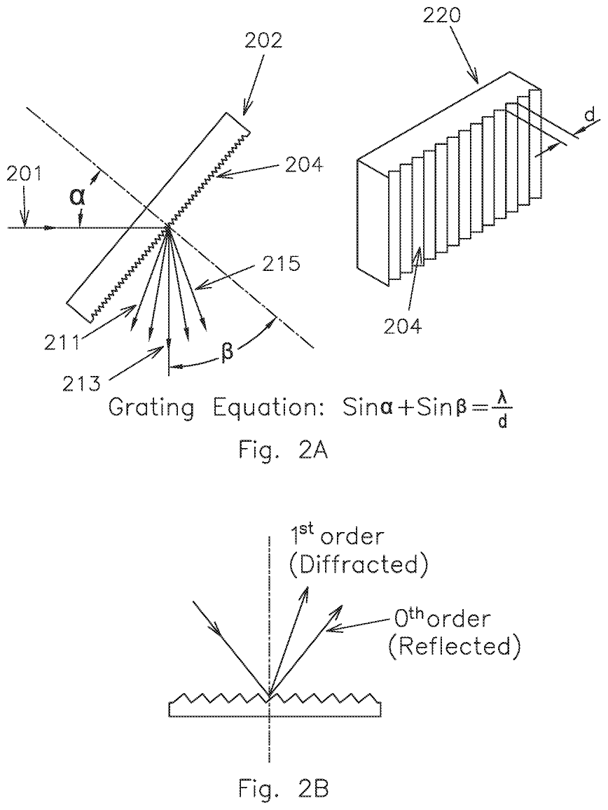

FIG. 2A illustrates the basic working principle of a diffraction grating. FIG. 2A shows a transmissive diffraction grating 202, whose incident beam 201 and its diffraction beams, represented by 211 through 215, are on opposite sides of the grating surface 204. Use of a reflective-type diffraction grating, is shown in FIG. 2B, where the diffracted beams are on the same side as the incident beam, is also applicable and within the scope of the present discussion.

In FIG. 2A, an incoming beam 201 carrying multiple wavelengths or a continuous wavelength spectrum, is incident on a diffraction grating 202, whose perspective view is shown as item 220. The beam is therefore diffracted or bent, and split into multiple wavelength components that exit the grating surface 204 at different angles. The longer the wavelength, the larger the bending angle. For example, ray 211 has a longer wavelength than that of ray 215. Ray 213 represents a ray whose wavelength is roughly in the middle of the angularly dispersed wavelength spectrum. The relationship between the exiting angle θ and the incident angle α follows the grating equation:

sin α+sin β=λ/d, (Equation 1)

where λ is wavelength and d is the groove distance, or pitch. Thus,

β=sin⁻¹(λ/d−sin α).

The dispersion coefficient D (the differential of the exiting angle β with respect to wavelength λ) can thus defined by:

D=D(λ,d,α)=dβ/dλ.

Generally, d, the groove distance or pitch, is on the order of the wavelength λ. The smaller the groove distance d is, the greater the dispersion ability. Conversely, the dispersion coefficient decreases with larger groove distance. For smaller or reduced wavelength dispersion, the groove distance d has to be increased. However, when the groove distance d becomes as large as a few multiples of the wavelength, the optical loss resulted from the grating becomes quite polarization dependent, which impairs the optical performance of devices that are built using diffraction gratings. For this and other reasons, a typical diffraction grating that is designed for operation in a wavelength range around 1550 nm will have a groove distance d of about 1 micron, and its dispersion coefficient is therefore around 0.08 degrees/nanometer.

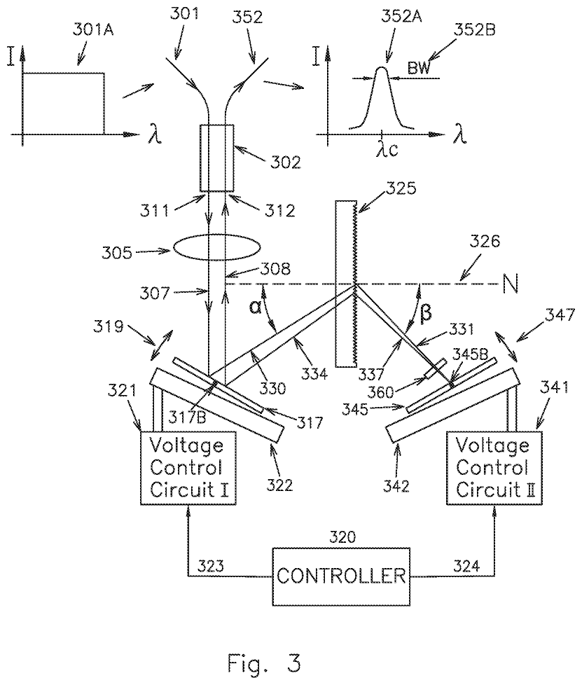

The embodiments described in the following present a grating system that can select a specific wavelength spectrum and also adjust its bandwidth, as shown in FIG. 3. An optical input, here a fiber 301, carries a continuous wavelength spectrum as indicated by 301A, multiple discrete wavelengths, or a mix of continuous spectrum and discrete wavelengths, and is encapsulated in a ferrule 302. Its fiber end 311 is an optical input port for the tunable optical filter, and is approximately located around the focal point of a lens 305. The optical power emitted from the fiber end 311 is collimated by the lens 305 to an optical beam denoted by ray 307, which is reflected by a first rotatable or tilting mirror 317 (for example, a MEMS tilt-mirror). The reflected beam 330 becomes an incident beam 330 to the diffraction grating 325, with an incident angle α. Incident angle α is adjustable, by rotating the mirror 317 around its pivot point 317B by the actuator 322, where the mirror 317 and actuator 322 can be a MEMs device. The rotation or tilt angle (indicated by 319) of the mirror 317 is controlled by a voltage control circuit 321 connected to actuator 322.

The beam 330 is then diffracted by the grating 325, to form a beam 331 with an angle (3, with respect to the normal 326 of the grating 325. The beam 331 is reflected by a second rotatable or tilting mirror 345, which rotates around pivot point 345B by the actuator 342, where the mirror 345 and actuator 342 can be a MEMs device. The mirror 345 is rotated (as indicated by 347) by a second voltage control circuit 341 connected to the actuator 342, to an optimal tilt angle, such that the reflected beam 337 is diffracted a second time by the diffraction grating. The resulting diffracted beam 334 is then reflected by the first mirror 317, to form beam 308, which is focused by lens 305 onto the optical output port, here the fiber end 312 of the output fiber 352.

The voltage control circuit 321 and voltage control circuit 341 can receive their respective inputs 323 and 324 from a controller 320 that may be part of one or more control circuits for the optical filter, which can allow a user to select both the wavelength center λ_{c} and a bandwidth or passband width for the output signal. The controller 320 can include a micro-controller (or microprocessor) chip that provides a digital “index value” corresponding to a user input for each of the control signals 323 and 324, to a corresponding DAC (digital to analog converter), which converts the index value to a low-level voltage that can then be amplified to a higher voltage by a corresponding op-amp. Depending on the embodiment, the controller 320 can be for a single tunable filter, or for one or more tunable filters or other components of an optical system.

The controller 320 can determine what digital index values to provide based on a translation of the desired filter bandwidth and center wavelength as provided by a user input, into the digital representations of the voltages to be applied to the actuators 322 and 342 for the rotatable mirrors 317 and 345. For example, in one set of embodiments the translation can be done by means of a look-up table, stored in either the on-chip memory of the controller 320, or in a separate memory device, and the look-up table can be initially created or populated by a calibration process done during manufacture.

The transmission loss of a grating is slightly dependent on the polarization of the incident beam. To avoid polarization dependent loss (PDL) from the input fiber 301 to the output fiber 352, a quarter-wave plate (for example, element 360), or a wave plate of some multiple of a quarter wave, may be interposed somewhere between the second mirror 345 and the grating 325 so that the polarization of the return beam (337 and 334) is orthogonal to the incoming beam (330 and 331). This effectively cancels out PDL for the overall tunable filter.

If a flat wavelength spectrum, such as indicated by 301A, propagates inside the optical fiber 301, the output spectrum is a narrower wavelength band (as indicated by 352A) that has a central wavelength at λ_{c} and a bandwidth or passband width BW 352B, which is usually defined by the wavelengths at which the optical power is reduced by 3 dB from its spectrum peak.

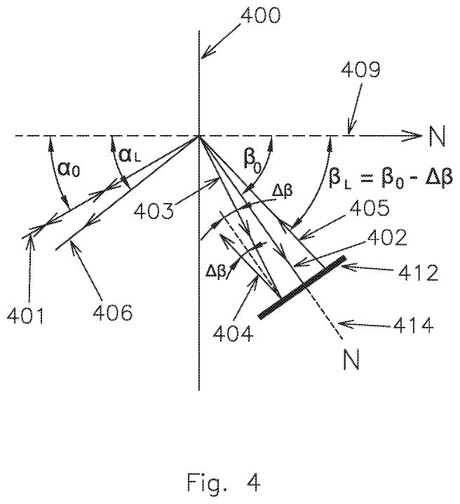

In summary, the first mirror 317 is used to change the incident angle α to the diffraction grating, and consequentially the exit angle (3. The change in the incident angle α is twice the change in the mirror's tilt angle. The second mirror 345 is used to select a central wavelength λ_{c} of the portion of the optical signal that enters the core of the output fiber 352, similar to the functioning of the single tilt mirror of the prior art tunable optical filter shown in FIG. 1. The incident angle α is not generally at the Littrow angle for the diffraction grating. (The Littrow angle for a diffraction grating is the angle at which the incident angle is equal to the diffraction angle.) The dispersion coefficient of the grating 325 (as described above) increases with an increase in the incident angle α, and thus the bandwidth of the output spectrum decreases (as explained in more detail below, in relation to FIG. 4). For an incident angle α that is substantially far from the Littrow angle, the transmission loss will be higher than it would be at the Littrow angle.

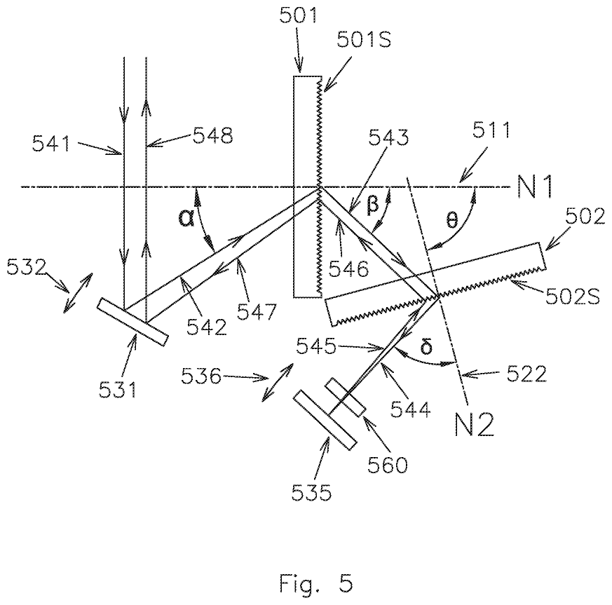

In the embodiment of FIG. 3, after reflecting off of the second mirror 345, the optical path to the output port (e.g., fiber end 312) passes through the diffraction grating 325 a second time and is then reflected a second time off of the first mirror 317, but alternate embodiments can use different geometries. For example, in alternate embodiments the light incident on the second mirror 345 can be directed to an output port 312 without a second pass through the diffraction element 325; and, in other embodiments, a second pass through diffraction element 325 can be used, after which the optical path goes to the output port without a second reflection off of the first mirror 317. Additionally, although FIG. 3 illustrates an embodiment where the refractive element is a single transmissive grating 325, other refractive elements can be used, including multiple transmissive gratings, or one or multiple reflective gratings, as shown in FIG. 5, and discussed below.

FIG. 4 provides a more detailed illustration of the principles of operation of the embodiment shown in FIG. 3. To simplify the illustration, as well as the mathematics, the optical input port (fiber end 311 of FIG. 3) and the optical output port (fiber end 312) are assumed to be very close to each other, such that the input beam 307 and the output beam 308 are almost coincident with each other, as shown by the bidirectional ray 401 in FIG. 4.

The notations used in FIG. 4 are defined below:
α₀: Incident angle of the multiple incoming wavelengths and the selected central wavelength λ₀ (also shown as λ_{c} in prior sections) to the output port (output fiber);
β₀: diffracted angle of central wavelength λ₀;
Δβ: angle deviation of the diffraction angles between the central wavelength and an off-center wavelength;
β_{L}: the second incident angle of a reflected off-center wavelength 405 (β_{L}=β₀−Δβ); and
α_{L}: the second diffracted angle of an off-center wavelength.

It should be noted that the various rays shown in FIG. 4 represent collimated beams. In particular, the reflected beam denoted by ray 404 is actually a collimated optical beam. Ray 405 is parallel to Ray 404 and represents the same collimated beam as ray 404. For graphic simplicity, ray 405 is also used to represent the reflected off-center wavelength.

Based on the grating Equation 1 above, the first diffraction for the central wavelength and the off-center wavelength respectively, are:

Sin α₀+Sin β₀=λ₀/d; and (Equation 2)

Sin α₀+Sin(β₀+Δβ)=/d (Equation 3)

The second diffraction for the reflected off-center wavelength is:

Sin(β₀−Δβ)+Sin α_{L}=λ_{L}/d (Equation 4)

Taking Equation 3 minus Equation 2 to the accuracy of the first order leads to:

Δβ/Δλ=1/(d Cos β₀), (Equation 5)

where Δλ=λ_{L}−λ₀. Taking Equation 4 minus Equation 3 to the accuracy of the first order leads to:

Δα/Δβ=2(Cos β₀/Cos α₀), (Equation 6)

where Δα=α_{L}−α₀ Multiplying Equation 6 by Equation 5 leads to:

Δα/Δλ=2/(d Cos α₀) (Equation 7)

Equation 7 shows that the dispersion coefficient of a round-trip diffraction depends on the incident angle α₀. The output fiber end has a fixed numerical aperture. The greater the wavelength dispersion is, the smaller the bandwidth or passband width of the output spectrum. Therefore, the bandwidth is decreased with increases of the first incident angle α₀. Changing the first incident α₀ by rotating the first mirror 317 in FIG. 3, results in the selection of the desired bandwidth or passband width BW. The bandwidth at α₀=35 degrees is about twice the bandwidth at α₀=66 degrees. The Littrow angle is typically in between these two angles.

More than one grating can be used in tandem as a grating system (such as described in U.S. Pat. No. 9,720,250), in order to achieve a dispersion coefficient beyond what a single grating can achieve. However, such a grating system is functionally equivalent to a single grating. FIG. 5 shows another embodiment of a bandwidth-adjustable tunable optical filter, comprising two diffraction gratings in tandem. The normal line N1 (511) of Grating 501, and the normal line N2 (522) of the grating 502, intersect each other with an included angle θ.

In FIG. 5, the incoming beam 541 is reflected by the rotating or tilting mirror 531 to become the incident beam 542 to the grating 501, which diffracts the incident beam 542 to the beam 543. A second grating 502 diffracts the beam 543 to the beam 544, which goes through a wave plate 560 and is then reflected by a second rotating or tilting mirror 535 to become beam 545. The return beam 545 is then diffracted again by the grating 502 and grating 501 in sequence to become beam 547, which is then reflected again by mirror 531 to become the output beam 548. An output fiber end face (not shown) therefore picks up the optical power carried by the output beam 548.

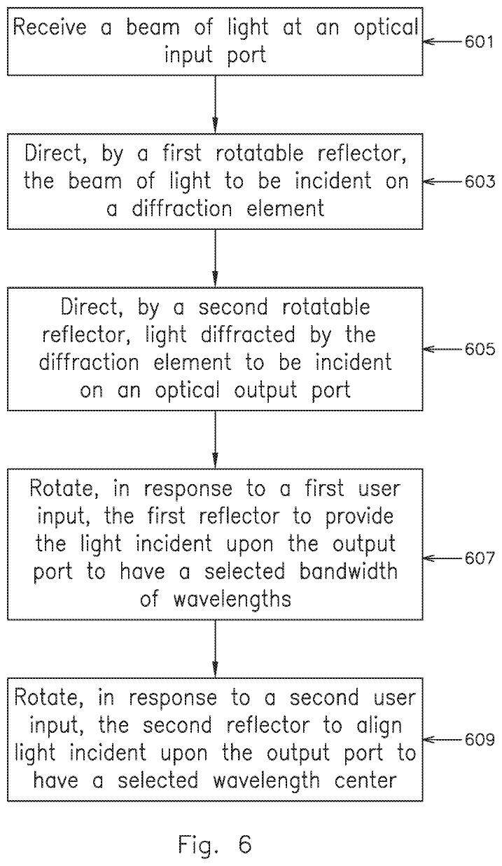

FIG. 6 is a flowchart for an embodiment of a method for operating a tunable optical filter device, such as presented above, to provide an output having a selected bandwidth of wavelengths about a selected wavelength center. Referring to the embodiment of FIG. 3, at step 601 a beam of light is received from an optical input port, such as the fiber end 311 of the input optical fiber 301. In FIG. 3, the beam of light is collimated by lens 305 on to the first rotatable reflector or mirror 317 that, as step 603, directs at least a portion of the beam of light to be incident on the diffraction element 325, which is a transmissive grating in this example. Light diffracted by the diffraction element 325 is directed by the second rotatable reflector or mirror 345 to be incident on the optical output port, such as the fiber end 312 of output fiber 352, as step 605. In the embodiment of FIG. 3, the optical path from the second mirror 345 to the optical output port makes a second pass through the grating 325 (and the quarter-wave plate 360) and is reflected a second time off the first mirror 317, but other embodiments can use different geometries and may lack one or both of the second pass through the grating 325 and the second reflection off of mirror 317.

At step 607, the first reflector 317 can be rotated based on a first user input so that the light incident on the output port (i.e., fiber end 312) has a selected bandwidth. In the example of FIG. 3, this can be based on the control signal 323 supplied to voltage control circuit I 321, which then adjusts the voltage level to the actuator 322 accordingly. At step 609, the second reflector 345 can be rotated based on a second user input so that the light incident on the output port (i.e., fiber end 312) has a selected wavelength center. In the example of FIG. 3, this can be based on the control signal 324 supplied to voltage control circuit II 341, which then adjusts the voltage level to the actuator 342 accordingly. Although presented in a particular order in FIG. 6 for presentation purposes, when the filter is in use, steps 601, 603, and 605 will all be occurring at the same time as part of the filtering process. Steps 607 and 609 are independent and can each be performed at any time while the filter is in operation, allowing real time adjustment, or beforehand.

Changing the passband width by rotating the first reflector 317 will necessitate a different angle of the second reflector 345 to have the same center wavelength as before. To change only the center wavelength, the second reflector 345 can be rotated. To change the passband width only while keeping the center wavelength the same, both the first reflector 317 and second reflector 345 are rotated as the change in the first reflector 317 to alter the passband will change the wavelength center as well, which can then be set back to the previous wavelength center by rotating the second reflector 345. Consequently, the control signals 323 and 324 can change the passband width and center wavelength independently, but changing passband width requires movement of both mirrors.

For purposes of this document, reference in the specification to “an embodiment,” “one embodiment,” “some embodiments,” or “another embodiment” may be used to describe different embodiments or the same embodiment.

For purposes of this document, a connection may be a direct connection or an indirect connection (e.g., via one or more other parts). In some cases, when an element is referred to as being connected or coupled to another element, the element may be directly connected to the other element or indirectly connected to the other element via intervening elements. When an element is referred to as being directly connected to another element, then there are no intervening elements between the element and the other element. Two devices are “in communication” if they are directly or indirectly connected so that they can communicate electronic signals between them.

For purposes of this document, the term “based on” may be read as “based at least in part on.”

For purposes of this document, without additional context, use of numerical terms such as a “first” object, a “second” object, and a “third” object may not imply an ordering of objects, but may instead be used for identification purposes to identify different objects.

For purposes of this document, the term “set” of objects may refer to a “set” of one or more of the objects.

The foregoing detailed description has been presented for purposes of illustration and description. It is not intended to be exhaustive or to limit to the precise form disclosed. Many modifications and variations are possible in light of the above teaching. The described embodiments were chosen in order to best explain the principles of the proposed technology and its practical application, to thereby enable others skilled in the art to best utilize it in various embodiments and with various modifications as are suited to the particular use contemplated. It is intended that the scope be defined by the claims appended hereto.

It is claimed:

1. A tunable optical filter device, comprising:
an optical input port;
an optical output port;
a diffraction element in an optical path between the input port and the output port, the diffraction element configured to differentially diffract light incident thereupon as based upon wavelength of the incident light;
a first rotatable reflector in the optical path, the first reflector configured to direct at least a portion of light having a wavelength spectrum incident thereupon from the input port to be incident upon the diffraction element, the angle of incidence upon the diffraction element dependent on an angle of the first rotatable reflector;
a second rotatable reflector in the optical path, the second reflector configured to direct at least a portion of light incident thereupon from the diffraction element to be incident upon an output port; and
one or more control circuits connected to, and configured to independently rotate, the first reflector and the second reflector, the one or more control circuits further configured to rotate the first reflector to provide the light incident upon the output port to have a selected bandwidth of wavelengths and to rotate the second reflector to align light incident upon the output port to have a selected wavelength center.

2. The tunable optical filter device of claim 1, wherein the first reflector is a first Micro-ElectroMechanical System (MEMS) device and the second reflector is a second MEMS device, and wherein the one or more control circuits connected to independently rotate the first reflector and the second reflector by respectively applying independent first and second control voltages to the first and second MEMS devices.

3. The tunable optical filter device of claim 1, further comprising:
a lens located in the optical path located between the input port and the first reflector, the lens configured to collimate light incident upon the first reflector from the input port.

4. The tunable optical filter device of claim 1, further comprising:
a ferrule including the input port and configured to hold a first optical fiber to supply the light having the wavelength spectrum.

5. The tunable optical filter device of claim 1, wherein the second reflector is further configured such that the optical path from the second reflector to the output port passes through the diffraction element a second time.

6. The tunable optical filter device of claim 5, further comprising: a quarter-wave plate located along the optical path between the diffraction element and the second reflector such the optical path passes through the quarter-wave plate both before and after the second reflector.

7. The tunable optical filter device of claim 5, wherein the first reflector is further configured such that, subsequent to passing through the diffraction element a second time, the optical path reflects off of the first reflector a second time between the diffraction element and the output port.

8. The tunable optical filter device of claim 5, further comprising:
a ferrule including the input port and the output port and configure to hold a first optical fiber to supply the light having the wavelength spectrum and hold a second optical fiber to receive light incident upon the output port.

9. The tunable optical filter device of claim 1, wherein the diffraction element is a transmissive grating.

10. The tunable optical filter device of claim 1, wherein the diffraction element is a reflective grating.

11. The tunable optical filter device of claim 1, wherein the diffraction element is a plurality of gratings in the optical path between the input port and the output port.

12. The tunable optical filter device of claim 1, wherein the diffraction element is in a fixed position relative to the optical input port.

13. The tunable optical filter device of claim 1, wherein the light incident upon the first reflector from the input port includes one or more continuous wavelength portions within a range of wavelengths or wavelength band.

14. A method, comprising:
receiving a beam of light at an optical input port;
directing, by a first rotatable reflector, at least a portion of the beam of light to be incident on a diffraction element, the diffraction element configured to differentially diffract light incident thereupon as based upon wavelength of the incident light;
directing, by a second rotatable reflector, light diffracted by the diffraction element to be incident on an optical output port;
rotating, in response to a first user input, the first reflector to provide the light incident upon the output port to have a selected bandwidth of wavelengths the second reflector to align light incident upon the output port to have a selected wavelength center; and
rotating, in response to a second user input, the second reflector to align light incident upon the output port to have a selected wavelength center.

15. The method of claim 14, wherein the first reflector is a first Micro-ElectroMechanical System (MEMS) device and the second reflector is a second MEMS device, and wherein:
rotating the first reflector includes adjusting a first voltage value supplied to the second MEMS device; and
rotating the second reflector includes adjusting a second voltage value supplied to the first MEMS device, the first and second voltage values being independently adjustable.

16. The method of claim 14, further comprising:
collimating light incident on the first reflector from the optical input port.

17. The method of claim 14, wherein directing light diffracted by the diffraction element to be incident on the optical output port includes:
directing, by a second rotatable reflector, to pass through the diffraction element a second time prior to being incident on the optical output port.

18. The method of claim 17, wherein directing light diffracted by the diffraction element to be incident on the optical output port further includes:
passing the light diffracted by the diffraction element to pass through a quarter-wave plate prior to being incident on the second reflector; and
passing the light directing by the second rotatable reflector to pass through a quarter-wave plate a second time prior to passing through the diffraction element the second time.

19. The method of claim 17, wherein directing light diffracted by the diffraction element to be incident on the optical output port further includes:
subsequent to passing the light diffracted by the diffraction element to be incident on the optical output port, reflecting the light off of the first reflector a second time.

20. The method of claim 14, wherein the diffraction element is a transmissive grating.

21. The method of claim 14, wherein the diffraction element is a reflective grating.

22. The method of claim 14, wherein the diffraction element is a plurality of gratings in the optical path between the input port and the output port.

23. The method of claim 14, wherein the diffraction element is a fixed position relative to the optical input port.

24. The method of claim 14, wherein the light incident upon the first reflector from the input port includes one or more continuous wavelength portions within a range of wavelengths or wavelength band.
